(19) United States
(12) Patent Application Publication
(10) Pub. No.: US 2015/0286843 A1
(43) Pub. Date: Oct. 8, 2015

(54) Method and system for modular digital watermarking of electronic files

(71) Applicant: William Brant, La Jolla, CA (US)

(72) Inventor: William Brant, La Jolla, CA (US)

(21) Appl. No.: 14/243,939

(22) Filed: Apr. 3, 2014

(51) Int. Cl. G06F 21/64; G06F 21/31; H04L 9/08; G06F 21/16; H04L 29/06

(52) U.S. Cl. CPC G06F 21/64; G06F 21/16; H04L 63/0428; H04L 9/08; H04L 63/08; G06F 21/31

(57) ABSTRACT

A method and system for modular digital watermarking of electronic files is disclosed. The method involves receiving a request for an electronic file, creating a digital watermark, duplicating the file, dividing the duplicate up to produce a plurality of substantially equal sections, and inserting a watermark into each section. The document may be provided to a user. A method for historical analysis of such documents involves scanning a received document to find watermarks, and analyzing the document or watermarks for information concerning the history of the file.

### TECHNICAL FIELD

Embodiments disclosed herein relate generally to methods and systems for computer security, and in particular to the use of digital watermarks.

### BACKGROUND ART

Breaches of the security systems in large sophisticated organizations have become commonplace, and the current trend only seems to show an increase in the number and severity of breaches. This trend has increased in spite of organizations deploying sophisticated appliances and specialty teams to protect sensitive data. Part of the problem is that data must typically be entrusted to some employees whose job requires access to the data. If such an employee decides to exploit that access for personal gain, for instance by selling the data or the access thereto to a malicious party, few technical safeguards can prevent the breech. A carefully executed theft can be difficult to trace, as there may be several persons in a position to carry it out.

Therefore, there remains a need for a robust way to determine how, when, and by whom the sensitive data was stolen.

### SUMMARY OF THE EMBODIMENTS

A method is disclosed for modular digital watermarking of electronic files. The method includes receiving, by a first computing device, from a second computing device, a request for a copy of an electronic file. The method further includes generating, by the first computing device, a digital watermark and generating, by the first computing device, a duplicate file that substantially matches the electronic file. The method additionally involves dividing, by the first computing device, the duplicate file to produce a plurality of substantially equal sections, and overwriting a portion of each section with the digital watermark.

In a related embodiment of the method, receiving also involves authenticating a user of the second computing device. In another embodiment, generating the digital watermark also involves including user data in the digital watermark. In still another embodiment, generating the digital watermark also involves including data concerning the second computing device in the digital watermark. In an additional embodiment, generating the digital watermark further involves including a network address of the second computing device in the digital watermark. Generating the digital watermark additionally involves including a timestamp in the digital watermark, in another embodiment. In an additional embodiment, generating the digital watermark also involves including a geographical location in the digital watermark. In yet another embodiment, generating the digital watermark further includes encrypting the digital watermark.

In another related embodiment, dividing further includes calculating the number of bits of the digital watermark and dividing the duplicate file to produce a plurality of substantially equal sections, where each section has at least as many bytes as the number of bits in the digital watermark. In an additional related embodiment, overwriting also includes, for each section, assigning a distinct byte in that section to each bit in the watermark and replacing one bit in each assigned byte with the corresponding bit in the watermark. In yet another embodiment, overwriting also involves obtaining, by the first computing device, a plurality of keys, producing a plurality of encrypted watermarks such that for each key of the plurality of keys there exists in the plurality of encrypted watermarks an encrypted copy of the watermark that has been encrypted by that key, and for each encrypted watermark in the plurality of watermarks, overwriting at least one section in the plurality of substantially equal sections. Still another embodiment of the method involves providing the duplicate file to a user.

A method is disclosed for historical analysis of modularly digitally watermarked electronic files. The method includes receiving, by a first computing device, an electronic file, determining, by the first computing device, that the electronic file contains at least one section containing a digital watermark, and determining, by the first computing device, historical information concerning the electronic file.

In a related embodiment of the method, determining that the electronic file contains at least one section containing a digital watermark also includes extracting, by the first computing device, the digital watermark from the at least one section. A related embodiment, in which the digital watermark is encrypted, also involves decrypting the digital watermark. In another related embodiment, determining historical information concerning the electronic file further includes comparing the digital watermark to data stored in memory accessible to the first computing device. In still another related embodiment, determining historical information concerning the electronic file also includes comparing the electronic file to at least one file stored in memory accessible to the first computing device. Determining historical information concerning the electronic file additionally involves determining a complete set of substantially equal sections into which the file is divided and enumerating the sections in the complete set of sections that contain a copy of the digital watermark, in another embodiment. In another embodiment still, determining the complete set of substantially equal sections further includes determining a section size for sections containing the digital watermark and determining, using that section size and the at least one section containing the digital watermark, a complete set of substantially equal sections into which the file is divided.

A system is also disclosed for modular digital watermarking of electronic files and for historical analysis of modularly digitally watermarked electronic files. The system includes a first computing device, an interface component, executing on the first computing device, and configured to receive, from a second computing device, a request for a copy of an electronic file, a watermark generator, executing on the first computing device, and configured to generate a digital watermark, and a file processor, executing on the first computing device, and configured to generate a duplicate file that substantially matches the electronic file, to divide the duplicate file into a plurality of substantially equal sections, and to overwrite a portion of each section with the digital watermark.

Other aspects, embodiments and features of the system and method will become apparent from the following detailed description when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the system and method shown where illustration is not necessary to allow those of ordinary skill in the art to understand the system and method.

### BRIEF DESCRIPTION OF THE DRAWINGS

The preceding summary, as well as the following detailed description of the disclosed system and method, will be better understood when read in conjunction with the attached drawings. It should be understood, however, that neither the system nor the method is limited to the precise arrangements and instrumentalities shown.

FIG. 1A is a schematic diagram depicting a computing device;

FIG. 1B is a schematic diagram depicting a network environment containing computing devices;

FIG. 2 is a schematic diagram depicting an embodiment of the disclosed system;

FIG. 3 is a flow chart illustrating one embodiment of the disclosed method; and

FIG. 4 is a flow chart illustrating another embodiment of the disclosed method.

### DETAILED DESCRIPTION OF SPECIFIC EMBODIMENTS

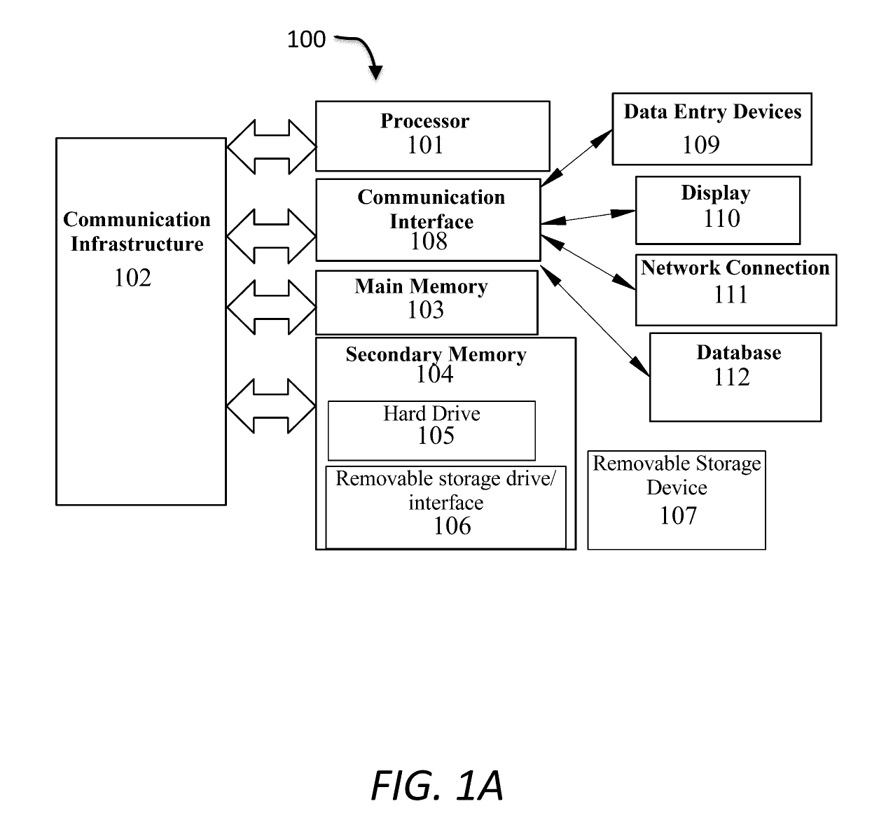

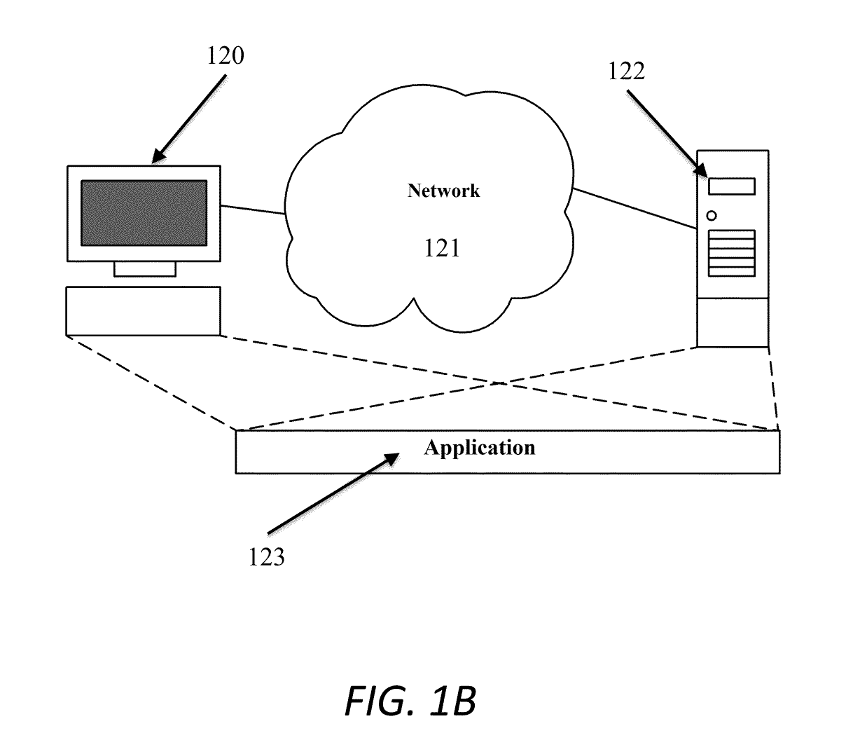

Some embodiments of the disclosed system and methods will be better understood by reference to the following comments concerning computing devices. A “computing device” may be defined as including personal computers, laptops, tablets, smart phones, and any other computing device capable of supporting an application as described herein. The system and method disclosed herein will be better understood in light of the following observations concerning the computing devices that support the disclosed application, and concerning the nature of web applications in general. An exemplary computing device is illustrated by FIG. 1A. The processor 101 may be a special purpose or a general-purpose processor device. As will be appreciated by persons skilled in the relevant art, the processor device 101 may also be a single processor in a multi-core/multiprocessor system, such system operating alone, or in a cluster of computing devices operating in a cluster or server farm. The processor 101 is connected to a communication infrastructure 102, for example, a bus, message queue, network, or multi-core message-passing scheme.

The computing device also includes a main memory 103, such as random access memory (RAM), and may also include a secondary memory 104. Secondary memory 104 may include, for example, a hard disk drive 105, a removable storage drive or interface 106, connected to a removable storage unit 107, or other similar means. As will be appreciated by persons skilled in the relevant art, a removable storage unit 107 includes a computer usable storage medium having stored therein computer software and/or data. Examples of additional means creating secondary memory 104 may include a program cartridge and cartridge interface (such as that found in video game devices), a removable memory chip (such as an EPROM, or PROM) and associated socket, and other removable storage units 107 and interfaces 106 which allow software and data to be transferred from the removable storage unit 107 to the computer system. In some embodiments, to “maintain” data in the memory of a computing device means to store that data in that memory in a form convenient for retrieval as required by the algorithm at issue, and to retrieve, update, or delete the data as needed.

The computing device may also include a communications interface 108. The communications interface 108 allows software and data to be transferred between the computing device and external devices. The communications interface 108 may include a modem, a network interface (such as an Ethernet card), a communications port, a PCMCIA slot and card, or other means to couple the computing device to external devices. Software and data transferred via the communications interface 108 may be in the form of signals, which may be electronic, electromagnetic, optical, or other signals capable of being received by the communications interface 108. These signals may be provided to the communications interface 108 via wire or cable, fiber optics, a phone line, a cellular phone link, and radio frequency link or other communications channels. Other devices may be coupled to the computing device 100 via the communications interface 108. In some embodiments, a device or component is “coupled” to a computing device 100 if it is so related to that device that the product or means and the device may be operated together as one machine. In particular, a piece of electronic equipment is coupled to a computing device if it is incorporated in the computing device (e.g. a built-in camera on a smart phone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the computing device by shared membership in some network consisting of wireless and wired connections between multiple machines (e.g. a printer in an office that prints documents to computers belonging to that office, no matter where they are, so long as they and the printer can connect to the internet). A computing device 100 may be coupled to a second computing device (not shown); for instance, a server may be coupled to a client device, as described below in greater detail.

The communications interface in the system embodiments discussed herein facilitates the coupling of the computing device with data entry devices 109, the device's display 110, and network connections, whether wired or wireless 111. In some embodiments, “data entry devices” 109 is are any equipment coupled to a computing device that may be used to enter data into that device. This definition includes, without limitation, keyboards, computer mice, touchscreens, digital cameras, digital video cameras, wireless antennas, Global Positioning System devices, audio input and output devices, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure. A computing device's “manual data entry devices” is the set of all data entry devices coupled to the computing device that permit the user to enter data into the computing device using manual manipulation. Manual entry devices include without limitation keyboards, keypads, touchscreens, track-pads, computer mice, buttons, and other similar components. A computing device may also possess a navigation facility. The computing device's “navigation facility” may be any facility coupled to the computing device that enables the device accurately to calculate the device's location on the surface of the Earth. Navigation facilities can include a receiver configured to communicate with the Global Positioning System or with similar satellite networks, as well as any other system that mobile phones or other devices use to ascertain their location, for example by communicating with cell towers.

In some embodiments, a computing device's “display” 109 is a device coupled to the computing device, by means of which the computing device can display images. Display include without limitation monitors, screens, television devices, and projectors.

Computer programs (also called computer control logic) are stored in main memory 103 and/or secondary memory 104. Computer programs may also be received via the communications interface 108. Such computer programs, when executed, enable the processor device 101 to implement the system embodiments discussed below. Accordingly, such computer programs represent controllers of the system. Where embodiments are implemented using software, the software may be stored in a computer program product and loaded into the computing device using a removable storage drive or interface 106, a hard disk drive 105, or a communications interface 108.

The computing device may also store data in database 112 accessible to the device. A database 112 is any structured collection of data. As used herein, databases can include “NoSQL” data stores, which store data in a few key-value structures such as arrays for rapid retrieval using a known set of keys (e.g. array indices). Another possibility is a relational database, which can divide the data stored into fields representing useful categories of data. As a result, a stored data record can be quickly retrieved using any known portion of the data that has been stored in that record by searching within that known datum's category within the database 112, and can be accessed by more complex queries, using languages such as Structured Query Language, which retrieve data based on limiting values passed as parameters and relationships between the data being retrieved. More specialized queries, such as image matching queries, may also be used to search some databases. A database can be created in any digital memory.

Persons skilled in the relevant art will also be aware that while any computing device must necessarily include facilities to perform the functions of a processor 101, a communication infrastructure 102, at least a main memory 103, and usually a communications interface 108, not all devices will necessarily house these facilities separately. For instance, in some forms of computing devices as defined above, processing 101 and memory 103 could be distributed through the same hardware device, as in a neural net, and thus the communications infrastructure 102 could be a property of the configuration of that particular hardware device. Many devices do practice a physical division of tasks as set forth above, however, and practitioners skilled in the art will understand the conceptual separation of tasks as applicable even where physical components are merged.

The systems may be deployed in a number of ways, including on a stand-alone computing device, a set of computing devices working together in a network, or a web application. Persons of ordinary skill in the art will recognize a web application as a particular kind of computer program system designed to function across a network, such as the Internet. A schematic illustration of a web application platform is provided in FIG. 1A. Web application platforms typically include at least one client device 120, which is an computing device as described above. The client device 120 connects via some form of network connection to a network 121, such as the Internet. The network 121 may be any arrangement that links together computing devices 120, 122, and includes without limitation local and international wired networks including telephone, cable, and fiber-optic networks, wireless networks that exchange information using signals of electromagnetic radiation, including cellular communication and data networks, and any combination of those wired and wireless networks. Also connected to the network 121 is at least one server 122, which is also an computing device as described above, or a set of computing devices that communicate with each other and work in concert by local or network connections. Of course, practitioners of ordinary skill in the relevant art will recognize that a web application can, and typically does, run on several servers 122 and a vast and continuously changing population of client devices 120. Computer programs on both the client device 120 and the server 122 configure both devices to perform the functions required of the web application 123. Web applications 123 can be designed so that the bulk of their processing tasks are accomplished by the server 122, as configured to perform those tasks by its web application program, or alternatively by the client device 120. Some web applications 123 are designed so that the client device 120 solely displays content that is sent to it by the server 122, and the server 122 performs all of the processing, business logic, and data storage tasks. Such “thin client” web applications are sometimes referred to as “cloud” applications, because essentially all computing tasks are performed by a set of servers 122 and data centers visible to the client only as a single opaque entity, often represented on diagrams as a cloud.

Many computing devices, as defined herein, come equipped with a specialized program, known as a web browser, which enables them to act as a client device 120 at least for the purposes of receiving and displaying data output by the server 122 without any additional programming. Web browsers can also act as a platform to run so much of a web application as is being performed by the client device 120, and it is a common practice to write the portion of a web application calculated to run on the client device 120 to be operated entirely by a web browser. Such browser-executed programs are referred to herein as “client-side programs,” and frequently are loaded onto the browser from the server 122 at the same time as the other content the server 122 sends to the browser. However, it is also possible to write programs that do not run on web browsers but still cause an computing device to operate as a web application client 120. Thus, as a general matter, web applications 123 require some computer program configuration of both the client device (or devices) 120 and the server 122. The computer program that comprises the web application component on either computing device's system FIG. 1A configures that device's processor 200 to perform the portion of the overall web application's functions that the programmer chooses to assign to that device. Persons of ordinary skill in the art will appreciate that the programming tasks assigned to one device may overlap with those assigned to another, in the interests of robustness, flexibility, or performance. Furthermore, although the best known example of a web application as used herein uses the kind of hypertext markup language protocol popularized by the World Wide Web, practitioners of ordinary skill in the art will be aware of other network communication protocols, such as File Transfer Protocol, that also support web applications as defined herein.

Embodiments of the disclosed system and methods provide for the clandestine insertion into an electronic file of data describing the manner in which a particular instance of the file was retrieved or viewed. The secretly inserted data is not readily detectable, so a person possessing such a file is likely to be insufficiently aware of its presence to intentionally destroy the data. The concealed data is also repeated throughout the file so that alterations to the file will be unlikely to destroy all instances of the data within the file. As a result, if a file containing confidential data is stolen and later recovered, it is possible to trace it to the source of the breech. Analysis of changes to the file and its embedded watermarks also make it possible to determine how the file has been changed since it was last legitimately accessed.

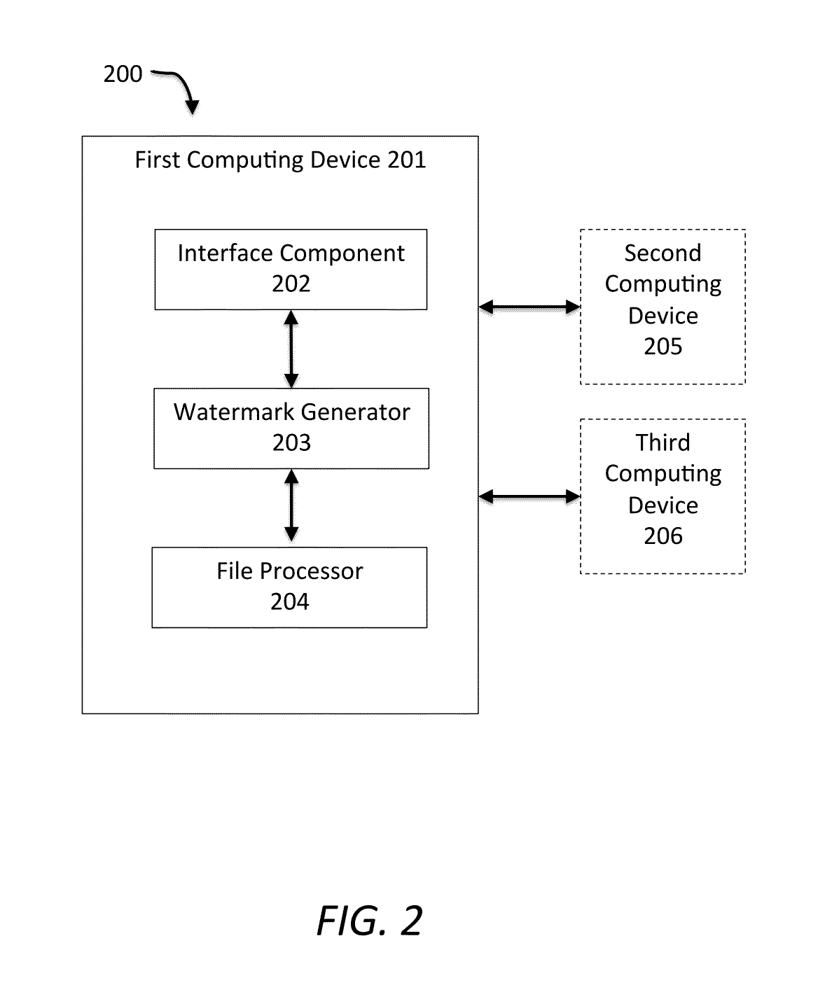

FIG. 2 depicts a system 200 for modular digital watermarking of electronic files. As an overview, the system includes a computing device 201. Executing on the computing device 201 is a set of algorithmic steps that may be conceptually described as creating an interface component 202, a watermark generator 203, and a file processor 204. The organization of tasks into those three components solely reflects a categorization of the tasks to be performed, and does not dictate the architecture of particular implementations of the system 200. For instance, in some embodiments of the system 200, the steps performed are executed by various objects in an object-oriented language, but the objects divide the tasks in a different manner than the above division. In other embodiments, the algorithmic steps exist as a set of instructions in a non-object oriented language, with no explicit separation of responsibility for steps into distinct components at all. Persons skilled in the art will recognize the existence of a broad variety of programming approaches that could cause the computing device 201 to perform the algorithmic steps.

Embodiments of the disclosed system and method involve the manipulation of electronic files. In some embodiments, electronic files, also referred to as “files,” are sets of data stored persistently in memory coupled to a computing device, such as a computing device 100 as described above in reference to FIGS. 1A-1B. In some embodiments, the data associated with a particular file are stored, retrieved, and manipulated in concert, creating an effect for the user analogous to that of retrieving and viewing a paper file. The data in a file may be stored in the form of bytes; for example, the file may be manipulated by the computing device as an array of bytes. The data in the file may be portrayed to a user by data output devices coupled to the computing device, as dictated by the formatting convention associated with the file. For instance, a file that the first computing device 201 identifies as containing an image, such as a Joint Photographic Experts Group (“JPEG”) file, may be provided to an end user as an image depicted on the display of the computing device, in which the color, brightness, and other attributes of each pixel in the image is determined by the computing device's interpretation of the data stored in the file. Likewise, data from a file identified by the computing device as containing audio data, such as a Moving Pictures Experts Group-Audio Layer III (MP3) file, may be provided to the user in the form of sound produced via by a speaker coupled to the computing device.

Embodiments of the disclosed system and method involve the manipulation, insertion, and retrieval of digital watermarks. In some embodiments, a digital watermark is a set of data inserted in a file to aid in tracking the source of and alterations to the file. The watermark may be concealed in file in a manner that makes the digital watermark difficult or impossible to detect when the file is viewed according to its typical use by an end user. Digital watermarks may be more readily concealed in files of types in which a certain degree of distortion, or “noise” is typical, such as image files, portable document files (PDF), MP3s, and video files. Files with particularly simple formats, such as text files, may present a greater challenge for the concealment of a digital watermark. In some embodiments, digital watermarks contain metadata concerning the creation or authorship of the file. In other embodiments, a digital watermark contains any information the entity causing its insertion considers useful.

Some embodiments of the disclosed invention involve the use of cryptosystems. In one embodiment, a cryptosystem is a system that converts data from a first form, known as “plaintext,” which is intelligible when viewed in its intended format, into a second form, known as “cyphertext,” which is not intelligible when viewed in the same way. The cyphertext is may be unintelligible in any format unless first converted back to plaintext. In one embodiment, the process of converting plaintext into cyphertext is known as “encryption.” The encryption process may involve the use of a datum, known as an “encryption key,” to alter the plaintext. The cryptosystem may also convert cyphertext back into plaintext, which is a process known as “decryption.” The decryption process may involve the use of a datum, known as a “decryption key,” to return the cyphertext to its original plaintext form. In embodiments of cryptosystems that are “symmetric,” the decryption key is essentially the same as the encryption key: possession of either key makes it possible to deduce the other key quickly without further secret knowledge. The encryption and decryption keys in symmetric cryptosystems may be kept secret, and shared only with persons or entities that the user of the cryptosystem wishes to be able to decrypt the cyphertext. One example of a symmetric cryptosystem is the Advanced Encryption Standard (“AES”), which arranges plaintext into matrices and then modifies the matrices through repeated permutations and arithmetic operations with an encryption key. In embodiments of cryptosystems that are “asymmetric,” either the encryption or decryption key cannot be readily deduced without additional secret knowledge, even given the possession of the corresponding decryption or encryption key, respectively; a common example is a “public key cryptosystem,” in which possession of the encryption key does not make it practically feasible to deduce the decryption key, so that the encryption key may safely be made available to the public. An example of a public key cryptosystem is RSA, in which the encryption key involves the use of numbers that are products of very large prime numbers, but the decryption key involves the use of those very large prime numbers, such that deducing the decryption key from the encryption key requires the practically infeasible task of computing the prime factors of a number which is the product of two very large prime numbers.

In some embodiments, the cryptosystem is designed so that it is either very difficult or impossible to decrypt the cyphertext without the decryption key. In computationally secure cryptosystems, decrypting the cyphertext requires a computing device attempting decryption without the decryption key sufficiently large number of steps that any currently available computing device would be unable to complete such a decryption in any practically useful amount of time; for instance, breaking a single instance of a computationally secure cyphertext with the best available computers might take several years. In information-theoretically secure cryptosystems, decrypting the cyphertext without the decryption key is impossible even given unlimited computing power, provided certain assumptions concerning the circumstances of the cryptosystem's use are met. Computationally secure cryptosystems may become insecure either because somebody discovers a way to decrypt cyphertext without an encryption key in fewer computing steps, known as “breaking” the cryptosystem, or because computing devices develop to the point where decryption without a decryption key and without breaking the cryptosystem, which is known as the “brute force” approach, becomes practically feasible. An information-theoretically secure cryptosystem cannot become insecure unless somebody breaks it. A particular implementation of a cryptosystem may also be broken because that the way in which that implementation was designed failed to accomplish the degree of security theoretically possible for the cryptosystem. The cryptosystem may be broken for all implementations, which involve discovering a flaw in the theoretical degree of security in the cryptosystem.

Some embodiments of the disclosed system involve the use of digital certificates. In one embodiment, a digital certificate is a file that conveys information and links the conveyed information to a “certificate authority” that is the issuer of a public key in a public key cryptosystem. The linking may be performed by the formation of a digital signature, in which the certificate authority encrypts a mathematical representation of the certificate using the private key in the cryptosystem, and verification involves decrypting the encrypted mathematical representation and comparing the decrypted representation to a purported match that was not encrypted; if well-designed, this means the ability to create the digital signature is equivalent to possession of the private decryption key. The certificate may contain the digital signature. The certificate may contain the mathematical representation to which the signature may be compared. The certificate may contain a copy of the public encryption key associated with the cryptosystem. The certificate in some embodiments contains data conveying the certificate authority's authorization for the recipient to perform a task. The authorization may be the authorization to access a given datum. The authorization may be the authorization to access a given process. The authorization may be the authorization to access a given computing device, such as a computing device 100 as disclosed above in reference to FIG. 1A. In some embodiments, the certificate may identify the certificate authority. In some embodiments, the certificate may identify the certificate holder; for instance, if the certificate holder is a user, it may contain the user's unique identifier within a system. If the certificate is associated with a particular device, it may contain that device's unique identifier within a system. In some embodiments, the certificate contains a serial number identifying the certificate. In some embodiments, the certificate contains limitations for the certificate's use. For instance, the certificate may have an expiration date, after which the certificate is no longer valid. The certificate may limit its validity to use with a particular computing device. The certificate may limit its validity to use at a particular geographic location; for instance, the certificate may only be valid within a certain distance, as defined by a navigation facility's norm, from a point located by that navigation facility. As another example, the certificate may limit its validity to a computing device currently within range of a particular wireless transmitter such as a “wi-fi” hub.

Referring to FIG. 2 in more detail, the system 200 includes a computing device 201. In some embodiments, the computing device 201 is a computing device 100 as disclosed above in reference to FIG. 1A. In other embodiments, the computing device 201 is a set of computing devices 100, as discussed above in reference to FIG. 1A, working in concert; for example, the computing device 201 may be a set of computing devices in a parallel computing arrangement. The computing device 201 may be a set of computing devices 100 coordinating their efforts over a private network, such as a local network or a virtual private network (VPN). The computing device 201 may be a set of computing devices 100 coordinating the efforts over a public network, such as the Internet. The division of tasks between computing devices 100 in such a set of computing devices working in concert may be a parallel division of tasks or a temporal division of tasks; as an example, several computing devices 100 may be working in parallel on components of the same tasks at the same time, where as in other situations one computing device 100 may perform one task then send the results to a second computing device 100 to perform a second task. In one embodiment, the computing device 201 is a server 122 as disclosed above in reference to FIG. 1B. The computing device 201 may communicate with one or more additional servers 122. The computing device 201 and the one or more additional servers 122 may coordinate their processing to emulate the activity of a single server 122 as described above in reference to FIG. 1B. The computing device 201 and the one or more additional servers 122 may divide tasks up heterogeneously between devices; for instance, the computing device 201 may delegate the tasks of the interface component 202 to an additional server 122. In some embodiments, the computing device 201 functions as a client device 120 as disclosed above in reference to FIG. 1B.

The interface component 202 executes on the computing device 201. The interface component 202 in some embodiments is a computer program as described above in reference to FIGS. 1A and 1B. In some embodiments, the interface component 202 is configured to receive, from a second computing device 205, a request for a copy of an electronic file, as set forth in more detail below. In some embodiments, the second computing device 205 is a client device 120 as described above in reference to FIG. 1B. In some embodiments, the interface component 202 communicates with one or more client devices 120 via a network, as disclosed above in reference to FIG. 1B. In additional embodiments, the interface component 202 communicates with one or more servers 122 via a network, as disclosed above in reference to FIG. 1B.

The watermark generator 203 executes on the computing device 201. The watermark generator 203 in some embodiments is a computer program as described above in reference to FIGS. 1A and 1B. In some embodiments, the watermark generator 203 receives data concerning the request for the file from the interface component 202. In some embodiments, the watermark generator 203 is configured to generate a digital watermark, as set forth in more detail below.

The file processor 204 executes on the computing device 201. The file processor 204 in some embodiments is a computer program as described above in reference to FIGS. 1A and 1B. In some embodiments, the file processor 204 receives data concerning the request for the file from the interface component 202. In some embodiments, the file processor 204 is configured to generate a duplicate file that substantially matches the electronic file, to divide the duplicate file into a plurality of substantially equal sections, and to overwrite a portion of each section with the digital watermark, as set forth in more detail below.

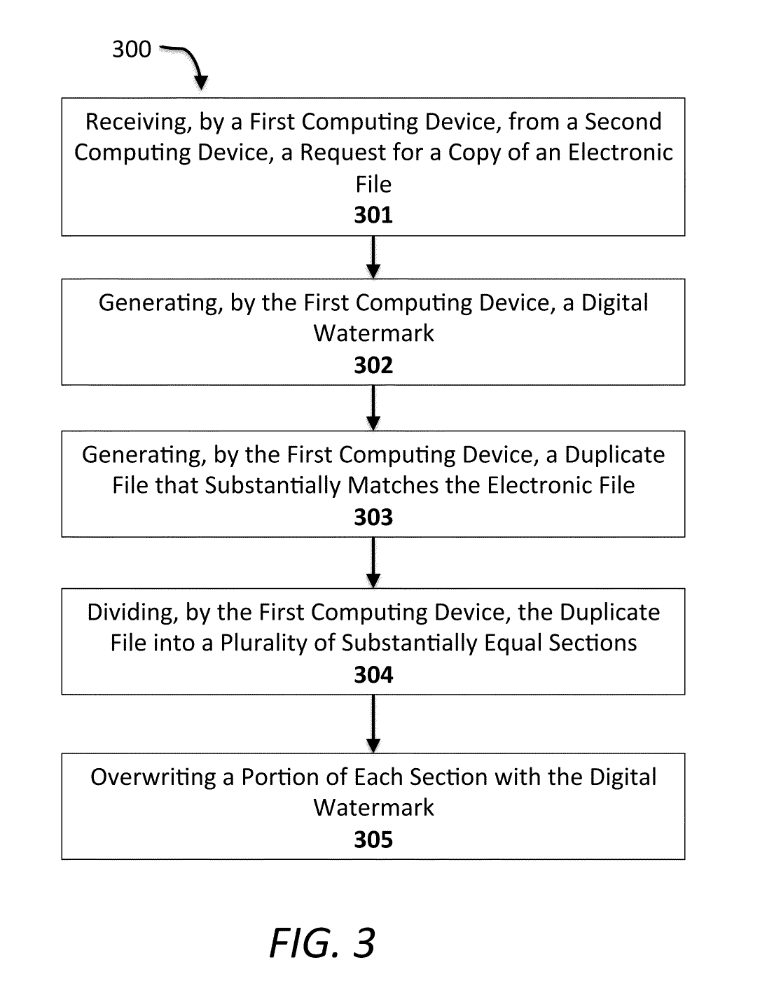

FIG. 3 illustrates some embodiments of a method 300 for modular digital watermarking of electronic files. The method 300 includes receiving, by a first computing device, from a second computing device, a request for a copy of an electronic file (301). The method includes generating, by the first computing device, a digital watermark (302). The method 300 includes generating, by the first computing device, a duplicate file that substantially matches the electronic file (303). The method 300 includes dividing, by the first computing device, the duplicate file to produce a plurality of substantially equal sections (304). The method 300 includes overwriting a portion of each section of the plurality of substantially equal sections with the digital watermark (305).

Referring to FIG. 3 in greater detail, and by reference to FIG. 2, the interface component 202 receives a request for a copy of an electronic file from a second computing device 205 (301). The request may originate from a user of the second computing device 205; for instance, the user may be an employee attempting to access the file to use the data contained in the file. The request may originate from an automated process within the second computing device 205. As an example, the user may be an employee operating an application that automatically retrieves documents as necessary to support the employee's tasks. The request may originate from the user of another computing device; for instance, the user of the second computing device 205 may be an employee recently assigned a task by a manager who is the user of another computing device, and that manager may also request the provision of documents to the employee pursuant to that assignment.

In some embodiments, receiving the request involves authenticating a user of the second computing device 205. In some embodiments, the interface component 202 authenticates the user by requesting, from the second computing device 205, digital certificates. The digital certificates may identify the user of the second computing device 205. The digital certificates may identify the second computing device 205. The digital certificates may describe the actions the user is authorized to take; for instance, the digital certificates may enable the first computing device 201 to determine which files the user is authorized to view. The organization employing the user may have a certificate authority that sets default security levels and delegates security settings to user-specific security authorities. Each user-specific security authority may be specifically linked to a unique identifier associated with a specific user account. The user-specific certificate authority may issue certificates permitting the user access to devices or processes. In some embodiments, each device registered to the user is given a special-purpose certificate that is created specifically for that device and is also chained to the user certificate authority; as a result, a certificate stored on the second computing device 205 may only grant the user privilege to perform a certain task while using that device. A user certificate may permit the user to access a particular Remote Desktop Protocol (“RDP”) server. A user certificate may permit the user to access a particular virtual private network (“VPN”). A user certificate may permit the user to use a particular computing device. A user certificate may permit the user to start a workflow. A user certificate may control the user's ability to send email. A user certificate may control the user's ability to send messages, such as Simple Messaging Service (“SMS”) messages. In some embodiments, the user credentials are encrypted.

In additional embodiments, certificates are assigned to users and devices according to role-based security. Role-based security may grant the user associated with a certificate certain access rights based on the role the user has been assigned to perform. In some embodiments, users may share credentials with other users assigned similar roles. In some embodiments, authenticating the user involves requesting the user to submit a personal identification number (“PIN”). The PIN may be a string of any symbols that the user can produce on a computing device; for instance, the PIN may be a sequence of alphanumeric characters. The user may enter the PIN using data entry means coupled to the second computing device 205. The user may enter the PIN using data entry means coupled to an additional computing device; for instance, the user may be required to enter the PIN through a second device assigned to the user, as a safeguard against theft and imposture. The first computing device 201 may compare the PIN to a PIN stored in memory accessible to the first computing device 201.

In some embodiments, receiving further involves authenticating the second computing device 205. Authenticating the second device may involve determining that the second device is one that the user may use to access the requested file. The second computing device 205 may have a unique identifier stored in memory accessible to the first computing device 201. A unique identifier corresponding to the user of the second computing device 205 may be linked in memory accessible to the first computing device 201 to the unique identifier of the second computing device 205. In some embodiments, the link is established by the assignment of the user to a particular role. In other embodiments, the link is established via a role assigned to the user. For instance, if the unique identifier of the user is listed as belonging to a particular work group, and the second computing device 205 is identified as available to that work group, the user may be linked to the second computing device 205.

In other embodiments, the second computing device 205 is dynamically registered to the user. For example second computing device 205 may generate an optically readable code, such as a bar code or quick read (“QR”) code and provide it to the user, for instance via the display of the second computing device 205 or via an attached printer. In some embodiments, the generation of the optically readable code occurs upon the user entering a request to use the second computing device 205 via the second computing device 205, for instance by clicking a link displaying on the second computing device 205. The user may scan the optically readable code using data entry means coupled to an additional computing device (not shown) already linked to the user. When the additional computing device inputs the optically readable code, it may convert it into binary data and transmit that data to memory accessible to the first computing device 201, thus causing the second computing device to be linked to the user. Information encoded in the optically readable code may include the geographic location of the second computing device 205; for instance, the code may include the Global Positioning System (“GPS”) Coordinates of the second computing device 205. The optically readable code may include an identifier, such as a name, associated with the second computing device 205. The optically readable code may include a network address, such as an internet protocol (“IP”) address associated with the second computing device 205. The optically readable code may include a name within a hierarchical naming system, such as the Domain Name System (“DNS”), associated with the second computing device 205.

In some embodiments, the interface component 202 authenticates the second computing device by determining the geographical location of the user. As a non-limiting example, the user already be linked an additional computing device (not shown), such as a smartphone, on the user's person, and the additional computing device may have a navigation facility. The additional computing device may communicate to the first computing device 201 when the user comes within a specific distance to the second computing device 205. The first computing device 201 may authenticate use by the user of the second computing device 205 only while the user is within a specified distance from the second computing device 205. Likewise, in some embodiments the first computing device 201 also automatically logs the user off of the second computing device 205 when the user, as represented by the user's additional computing device, moves more than a certain distance away from the second computing device 205. In some embodiments, authentication requires the user to access the requested file via a particular secured channel, such as a VPN, by authenticating the user only if the user is using that particular channel.

In some embodiments, when a user account is deleted, disabled or in some type of revoked status, the security authority associated with that user cuts off access for all of the user's devices as well. This also enables any information that is encrypted with the keys to be protected as well so the end user cannot gain access to any organization information that is stored on the second computing device 205.

In some embodiments, the interface component 202 authenticates the process the user is attempting to engage in. For instance, a policy may be stored in memory accessible to the first computing device 201 that permits automatic approval of any process presenting an overall risk that falls below a certain threshold amount. The overall risk may be calculated using the probability of a particular undesirable outcome, such as a data breach. The overall risk may be calculated using the likely cost of such an undesirable outcome, such as the dollar cost that would result if the data in a particular file were obtained by a malicious party. In some embodiments, the probability of an undesirable result is multiplied by the likely cost of the undesirable result to produce an overall risk score. In some embodiments, the calculation involves determining overall risk by assessing the probabilities of a plurality of potential undesirable outcomes, and developing a composite overall probability using that assessment. In other embodiments, the calculation involves determining overall risk by assessing the likely cost of a plurality of potential undesirable outcomes, and using that assessment to develop a composite overall likely cost. In some embodiments, the probabilities and likely costs of a plurality of undesirable scenarios are combined to determine an overall risk level. The determination of the overall risk level may be performed using estimates for probability of occurrence or likely cost input by users. The probabilities of occurrence and likely costs may be determined by a computing device by determining the relative frequencies and actual costs of past, similar occurrences. For instance, the first computing device 205 may determine the frequency of past data breaches relative to the volume of commerce at the category of institutions at which the breaches occurred. The first computing device 205 may determine a mean cost per breach or per file released in a breach of similar files. This automatic approval policy may enable business to maintain a more business-oriented methodology for process entitlement by removing lengthier approval processes that are not justified by the degree of risk. In some embodiments if the degree of risk of the action the user is requesting, as determined by the automated process, is too high, the first computing device 205 requires approval from an additional user, such as a manager, before the process is approved. In some embodiments, the policy is organization-wide. In other embodiments, the policy controls processes falling into a sub-organization category. For instance, the manager in charge of a department may establish the policy for that department. The organization may also have a policy that the manager cannot override; for instance, the organization may determine a maximal overall risk for automatic approval, and only permit managers to create policies using equal or lesser degrees of overall risk.

The method includes generating, by the first computing device, a digital watermark (302). The watermark generator 203 may generate the watermark by creating a collection, such as a string, containing at least one datum. The watermark generator 203 may create the watermark by combining a plurality of data. In some embodiments, the watermark generator 203 generates the digital watermark by including user data in the digital watermark. Including may be any manner of including a datum into a collection of data. Including may involve including all of the data to be included. Including may involve including part of the data to be included. For instance, if the user data to be included in the watermark is the user's last name, including might involve adding only the first four letters of the last name to the watermark. In some embodiments, including involves concatenating the data to the beginning of the watermark. In other embodiments, including involves concatenating the data to the end of the watermark. In still other embodiments, including involves inserting the data into the body of the watermark. Including may involve using the data and the watermark to perform an arithmetic operation, producing a new watermark.

In some embodiments, the watermark generator 203 generates the digital watermark by including data concerning the second computing device 205 in the digital watermark. The data concerning the second computing device may be obtained via any process described above in reference to FIG. 3. In other embodiments, the watermark generator 203 generates the digital watermark by including a network address of the second computing device in the digital watermark. In still other embodiments, the watermark generator 203 generates the digital watermark by including a timestamp in the digital watermark. A timestamp may be any element of data containing a time, a date, or any combination of the time and date. In some additional embodiments, the watermark generator 203 generates the digital watermark by including a geographical location in the digital watermark; for instance, the second computing device 205 may determine its geographic location using a navigation facility as described above in reference to FIG. 1A. The watermark generator 203 may receive the geographic location from the second computing device 205, and include that geographical location in the watermark.

In some embodiments, generating the digital watermark also involves encrypting the digital watermark. The watermark generator 203 may encrypt the watermark using a cryptosystem as disclosed above in reference to FIG. 2. In one embodiment, the watermark generator 203 encrypts the watermark using a symmetric cryptosystem. In other embodiments, the watermark generator 203 encrypts the watermark using an asymmetric cryptosystem. In some embodiments, the watermark generator 203 encrypts the watermark with a combination of a plurality of cryptosystems. The watermark generator 203 may encrypt the plaintext of the watermark with multiple keys; for instance, the watermark generator 203 may use a plurality of keys, and produce at least one copy of the watermark encrypted with each of the plurality of keys. In some embodiments, using multiple keys can ensure that the cyphertext produced by each key will contain a different sequence of bits than cyphertext produced by other keys, so that pattern-recognition algorithms will be less likely to detect the cyphertexts in the file by searching for repeated sequences of bits in apparent noise.

The file processor 204 generates a duplicate file that substantially matches the electronic file (303). The file processor 204 may generate a duplicate of the electronic file using any process suitable for retrieving and duplicating an electronic file. In some embodiments, the file processor 204 generates the duplicate file by retrieving the electronic file from the memory of the first computing device 201 and duplicating the electronic file. In other embodiments, the file processor 204 generates the duplicate file by retrieving the electronic file from a third computing device 206 and duplicating the electronic file. The file processor 204 may retrieve the electronic file from a cloud server. The file processor 204 may retrieve the electronic file from a database 112 as described above in reference to FIG. 1A. The file processor may retrieve the electronic file from multiple sources; for instance, several additional computing devices (not shown) may produce the electronic file by combining separately stored data. The several computing devices may combine the separately stored data via a secure multiparty computation algorithm.

The file processor 204 divides the duplicate file to produce a plurality of substantially equal sections (304). Dividing the duplicate file to produce a plurality of substantially equal sections may involve dividing the entire duplicate file into a plurality of substantially equal sections. Dividing the duplicate file to produce a plurality of substantially equal sections may involve dividing the duplicate file into a plurality of substantially equal sections in addition to one or more remainder sections that are not substantially equal to the sections in the plurality. In some embodiments, the file processor 204 divides the duplicate file into substantially equal sections according to a grid imposed upon a visual representation of the file; for instance, an image file as displayed to a user viewing the image file could be divided as if the user had cut the file into rectangular sections defined by a grid drawn on the image file. In other embodiments, the file processor 204 divides the duplicate file into a plurality of substantially equal sections by assigning bytes to each section according to a formula. For example, where the file is stored in memory as an array of bytes, and each substantially equal section contains 256 bytes, the first 256 bytes could be assigned to the first section, the second 256 bytes could be assigned to the second section, and so forth. As another example, the bytes in the array of bytes could be assigned to sections cyclically, with each byte being assigned to the section subsequent to the section to which the previous byte in the array was assigned. Persons skilled in the art will be aware of many ways in which elements of data making up a file may be assigned to sections dividing up the file. In some embodiments, the file processor 204 divides the duplicate file to produce a plurality of substantially equal sections by calculating the number of bits of the digital watermark and dividing the duplicate file to produce a plurality of substantially equal sections, wherein each section has at least as many bytes as the number of bits in the digital watermark.

The file processor overwrites a portion of each section in the plurality of substantially equal sections with the digital watermark (305). In some embodiments, the file processor 204 overwrites a portion of each section by assigning, for each section, a distinct byte in that section to each bit in the watermark, and replacing one bit in each assigned byte with the corresponding bit in the watermark. For instance, the file processor 204 may replace the right-most bit in each byte in the section with a bit from the watermark. Where the number of bytes in a section exceeds the number of bits in the watermark, the file processor 204 may select a subset of bytes from the total set of bytes in the section, such that the subset contains as many bytes as there are bits in the watermark, and replace the rightmost bit in each byte in the subset; for instance, the file processor 204 may traverse the bytes according to some order, replacing the right-most bit in each byte with a bit from the watermark, until the file processor 204 has exhausted all of the bits from the watermark. In some embodiments, the file processor 204 replaces the leftmost bit of each byte. In some embodiments, the file processor 204 replaces some interior bit in each byte. In some embodiments, the file processor 204 varies the location in each byte for bit replacement; for instance, the bit replaced in every second byte may be the leftmost bit, whereas the bit replaced in every oddly numbered byte may be the rightmost bit. In some embodiments, the file processor 204 varies the location within each section of at least one bit in the watermark. As an example, the file processor 204 may vary the order in which it inserts watermark bits as it traverses the bytes in a section. In some embodiments, the file processor 204 overwrites the bits by obtaining a plurality of keys, producing a plurality of encrypted watermarks such that for each key of the plurality of keys there is an encrypted copy of the watermark in the plurality of watermarks encrypted with that key, and for each encrypted watermark in the plurality of watermarks, overwriting at least one section in the plurality of substantially equal sections; this changes the values of the bits inserted from one section to another, making it more difficult to detect a pattern in the replaced bits, and thus making it harder to distinguish the watermarks inserted from random noise.

Some embodiments also involve providing the duplicate file to a user. The duplicate file may be provided by sending the file to the second computing device 205. The first computing device 201 may provide the duplicate file by causing it to be displayed on the second computing device 205. A security setting on the first computing device 201 may prevent the second computing device 205 from downloading the document. As a result, in some embodiments the only way to obtain information from displayed document appliance is to take a screen print or a photograph, capturing the digital watermark as well as the intended image.

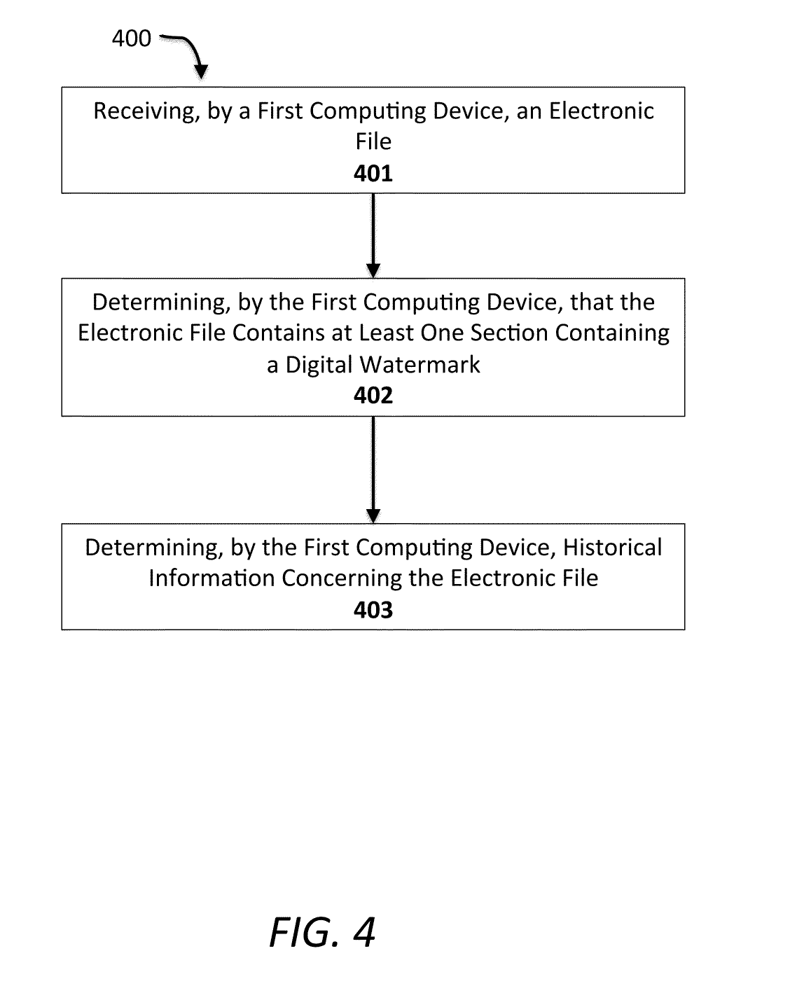

FIG. 4 illustrates some embodiments of a method 400 for source tracking of digitally watermarked electronic files. The method 400 includes receiving, by a first computing device, an electronic file (401). The method 400 includes determining, by the first computing device, that the electronic file contains at least one section containing a digital watermark (402). The method 400 includes determining, by the first computing device, historical information concerning the electronic file (403).

Referring to FIG. 4 in greater detail, and by reference to FIG. 2, the interface component 202 receives an electronic file (401). The interface component 202 may receive the second electronic file from a third computing device 206. The interface component 202 may receive the second electronic file from a memory (not shown) coupled to the first computer, such as a CD-ROM or a flash drive. The interface component 202 may receive the second electronic file from an optical capture device such as a camera or scanner.

The file processor 204 determines that the electronic file contains at least one section containing a digital watermark (402). The file processor 204 may determine that the electronic file contains a second digital watermark by determining that there is a pattern of apparently random noise that repeats, indicating intentionally inserted data. The file processor 204 may search for the pattern by searching in locations used by the file processor 204 to insert watermarks in other documents. For instance, the file processor 204 may search for patterns in the rightmost bits of each byte in the electronic file, if the file processor 204 inserts watermarks by replacing the rightmost bits of some bytes with bits from watermarks. In some embodiments, the file processor 204 compares the electronic file to files stored in memory accessible to the first computing device 201, and identifies a file stored in memory accessible to the first computing device 201 that matches the electronic file. The file processor 204 may then use stored information concerning the insertion of watermarks in past duplicates of the matching stored file to identify the location of watermarks in the electronic file. In some embodiments, the file processor 204 extracts the digital watermark from the at least one section. The file processor 204 may extract the digital watermark by finding the digital watermark and storing it in memory accessible to the first computing device 204. Where the digital watermark is encrypted, the file processor 204 may decrypt the digital watermark. The file processor 204 may decrypt the digital watermark using a cryptosystem as described above in reference to FIG. 2.

The method 400 includes determining, by the first computing device, historical information concerning the electronic file (403). The watermark generator 203 may extract any information that was included in the digital watermark as described above in reference to FIG. 3. The first computing device 201 may extract user data. The watermark generator 203 may extract data concerning a computing device, such as the computing device from which the request for the second electronic file was submitted when the electronic file was watermarked, as described above in reference to FIG. 3. The watermark generator 203 may extract geographic data. The data extracted from the digital watermark by the watermark generator 203 may enable a user of the first computing device 201 to discover the time and location at which the electronic file was taken, if it was illicitly copied from a computing device on which a user was viewing the file. The data extracted from the digital watermark may enable a user of the first computing device 201 to identify the person whose account was used to view the file, and the device used to view the file as well. Thus, the contents of the watermark can aid in investigating the source of a data breech involving the electronic file.

In some embodiments, the watermark generator 203 compares the digital watermark to data stored in memory accessible to the first computing device. For instance, the watermark generator 203 may search memory accessible to the first computing device 201 for user accounts matching a user account extracted from the watermark. The watermark generator 203 may search memory accessible to the first computing device for device information matching information extracted from the watermark concerning a computing device, such as the computing device from which the request for the electronic file was submitted when the second electronic file was watermarked, as described above in reference to FIG. 3. The watermark generator 203 may search memory accessible to the first computing device for geographical information matching geographical information extracted from the digital watermark. The watermark generator 203 may search memory accessible to the first computing device for timestamp information matching timestamp information extracted from the digital watermark. The first computing device 201 may provide matching data thus discovered to a user of the first computing device 201; for instance, the first computing device 201 may display matching data to a user.

In some embodiments, the file processor 204 determines historical information concerning the electronic file by comparing the electronic file to at least one file stored in memory accessible to the first computing device 201. In other embodiments, the file processor 204 determines historical information concerning the electronic file by determining a complete set of substantially equal sections into which the file is divided and enumerating the sections in that complete set of sections that contain a copy of the digital watermark. The enumeration may enumerate sections containing intact copies of the digital watermark. The enumeration may enumerate sections containing partial copies of the digital watermark. The file processor 204 may analyze the degree to which a partial copy of the digital watermark has been altered. The degree to which the file has been altered may be measured in some embodiments according to the number of sections that have been altered. If the watermark was inserted according to a known algorithm, such as one of the algorithms described above in reference to FIG. 3, the first computing device 201 may analyze the file using information concerning that algorithm, to determine the size of a section containing the digital watermark. For instance, if all sections containing the watermark in a document are created with substantially the same size, then determining the size of one section would enable the file processor 204 to determine the likely size of the other sections. Likewise, the manner of division of the file into sections may enable the file processor 204 to determine the number of sections and the data in the file that are likely to be contained in each section.

In some embodiments, the file processor 204 determines the complete set of substantially equal sections by determining a section size for sections containing the digital watermark and determining, using that section size and the at least one section containing the digital watermark, a complete set of substantially equal sections into which the file is divided. Thus, for instance, if the watermark is typically inserted by overwriting the rightmost bit of each byte in a section, then the number of bits in the watermark may determine the number of bytes in the section containing one instance of the watermark. The size and location within the file of the at least one section containing the watermark may aid in determining exactly how the file was divided. For instance, the contents of one section containing an instance of the watermark may eliminate most possible divisions into similarly-sized sections. Furthermore, the file processor 204 may use other discovered watermarks to eliminate possible divisions into sections by determining that one of several possible divisions would divide up an additional watermark between two sections, thus invalidating that division.

It will be understood that the system and method may be embodied in other specific forms without departing from the spirit or central characteristics thereof. The present examples and embodiments, therefore, are to be considered in all respects as illustrative and not restrictive, and the system method is not to be limited to the details given herein.

What is claimed is:

1. A method for modular digital watermarking of electronic files, the method comprising:
receiving, by a first computing device, from a second computing device, a request for a copy of an electronic file;
generating, by the first computing device, a digital watermark;
generating, by the first computing device, a duplicate file that substantially matches the electronic file;
dividing, by the first computing device, the duplicate file to produce a plurality of substantially equal sections; and
overwriting a portion of each section with the digital watermark.

2. A method according to claim 1, wherein receiving further comprises authenticating a user of the second computing device.

3. A method according to claim 1, wherein generating the digital watermark further comprises including user data in the digital watermark.

4. A method according to claim 1, wherein generating the digital watermark further comprises including data concerning the second computing device in the digital watermark.

5. A method according to claim 4, wherein generating the digital watermark further comprises including a network address of the second computing device in the digital watermark.

6. A method according to claim 1, wherein generating the digital watermark further comprises including a timestamp in the digital watermark.

7. A method according to claim 1, wherein generating the digital watermark further comprises including a geographical location in the digital watermark.

8. A method according to claim 1, wherein generating the digital watermark further comprises encrypting the digital watermark.

9. A method according to claim 1, wherein dividing further comprises:
calculating the number of bits of the digital watermark; and
dividing the duplicate file to produce a plurality of substantially equal sections, wherein each section has at least as many bytes as the number of bits in the digital watermark.

10. A method according to claim 9, wherein overwriting further comprising:
for each section, assigning a distinct byte in that section to each bit in the watermark; and
replacing one bit in each assigned byte with the corresponding bit in the watermark.

11. A method according to claim 1, wherein overwriting further comprises:
obtaining, by the first computing device, a plurality of keys;
producing a plurality of encrypted watermarks such that for each key of the plurality of keys there exists in the plurality of encrypted watermarks an encrypted copy of the watermark that has been encrypted by that key; and
for each encrypted watermark in the plurality of watermarks, overwriting at least one section in the plurality of substantially equal sections.

12. A method according to claim 1, further comprising providing the duplicate file to a user.

13. A method for historical analysis of modularly digitally watermarked electronic files, the method comprising:
receiving, by a first computing device, an electronic file;
determining, by the first computing device, that the electronic file contains at least one section containing a digital watermark; and
determining, by the first computing device, historical information concerning the electronic file.

14. A method according to claim 13, wherein determining that the electronic file contains at least one section containing a digital watermark further comprises extracting, by the first computing device, the digital watermark from the at least one section.

15. A method according to claim 14, wherein the digital watermark is encrypted, and further comprising decrypting the digital watermark.

16. A method according to claim 14, wherein determining historical information concerning the electronic file further comprises comparing the digital watermark to data stored in memory accessible to the first computing device.

17. A method according to claim 13, wherein determining historical information concerning the electronic file further comprises comparing the electronic file to at least one file stored in memory accessible to the first computing device.

18. A method according to claim 13, wherein determining historical information concerning the electronic file further comprises:
determining a complete set of substantially equal sections into which the file is divided; and
enumerating the sections in the complete set of sections that contain a copy of the digital watermark.

19. A method according to claim 18, where determining the complete set of substantially equal sections further comprises:
determining a section size for sections containing the digital watermark; and
determining, using that section size and the at least one section containing the digital watermark, a complete set of substantially equal sections into which the file is divided.

20. A system for modular digital watermarking of electronic files and for historical analysis of modularly digitally watermarked electronic files, the system comprising:
a first computing device;
an interface component, executing on the first computing device, and configured to receive, from a second computing device, a request for a copy of an electronic file;
a watermark generator, executing on the first computing device, and configured to generate a digital watermark; and
a file processor, executing on the first computing device, and configured to generate a duplicate file that substantially matches the electronic file, to divide the duplicate file into a plurality of substantially equal sections, and to overwrite a portion of each section with the digital watermark.
